(19) United States
(12) Patent Application Publication
(10) Pub. No.: US 2002/0198969 A1
(43) Pub. Date: Dec. 26, 2002

(54) Configuring network devices

(76) Inventors: Glenn R. Engel, Snohomish, WA (US); Glen Purdy JR., Snohomish, WA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 09/891,712

(22) Filed: Jun. 25, 2001

(51) Int. Cl. G06F 15/177; G06F 15/16

(52) U.S. Cl. 709/220; 709/203

(57) ABSTRACT

A method for configuring network devices under control of a configuration server. The configuration server loads an applet onto a node which is connected to a local network. The applet searches the local network for a network device. A set of network configuration parameters for the network device are then generated under control of the configuration server. The configuration server then transfers the network configuration parameters to the applet which relays them to the network device via the local network.

### BACKGROUND OF THE INVENTION

1. Field of Invention

The present invention pertains to the field of network devices. More particularly, this invention relates to configuring network devices.

2. Art Background

A wide variety devices have built in capabilities for network communication. A device capable of network communication may be referred to as a network device. Examples of network devices are numerous and include communication hubs, repeaters, routers, network bridges, computer systems, test equipment, and distributed control system devices to name a few examples.

Typically, the installation of a network device includes configuring the network device with an appropriate set of communication parameters. For example, a newly installed network device is usually configured with its IP address as well as the IP addresses for other relevant devices.

A typical prior network device is configured using a computer system having a specialized application program which is adapted to the network device. The computer system usually connects to the network device via a serial connection or a network connection. The specialized application program typically generates and transfers network configuration parameters to the network device via the serial or network connection.

Such specialized application programs are usually developed and maintained for a variety of different computer system platforms and operating systems. Unfortunately, the task of providing software support for such specialize application programs usually increases the costs of network device configuration.

### SUMMARY OF THE INVENTION

A method is disclosed for configuring network devices under control of a configuration server. The configuration server loads an applet onto a node which is connected to a local network. The applet searches the local network for network devices. A set of network configuration parameters for a found network device is generated under control of the configuration server. The configuration server then transfers the network configuration parameters to the applet which relays them to the network device via the local network. The fact that control over the configuration process resides with the configuration server avoids the use of specialized application programs for network device configuration.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 illustrates an arrangement for configuring a network device according to the present teachings;

FIG. 2 shows method steps performed by a remote configuration applet in one embodiment;

FIG. 3 illustrates a method for generating a set of network configuration parameters for a network device;

FIG. 4 illustrates an arrangement for configuring a set of network devices according to the present teachings.

### DETAILED DESCRIPTION

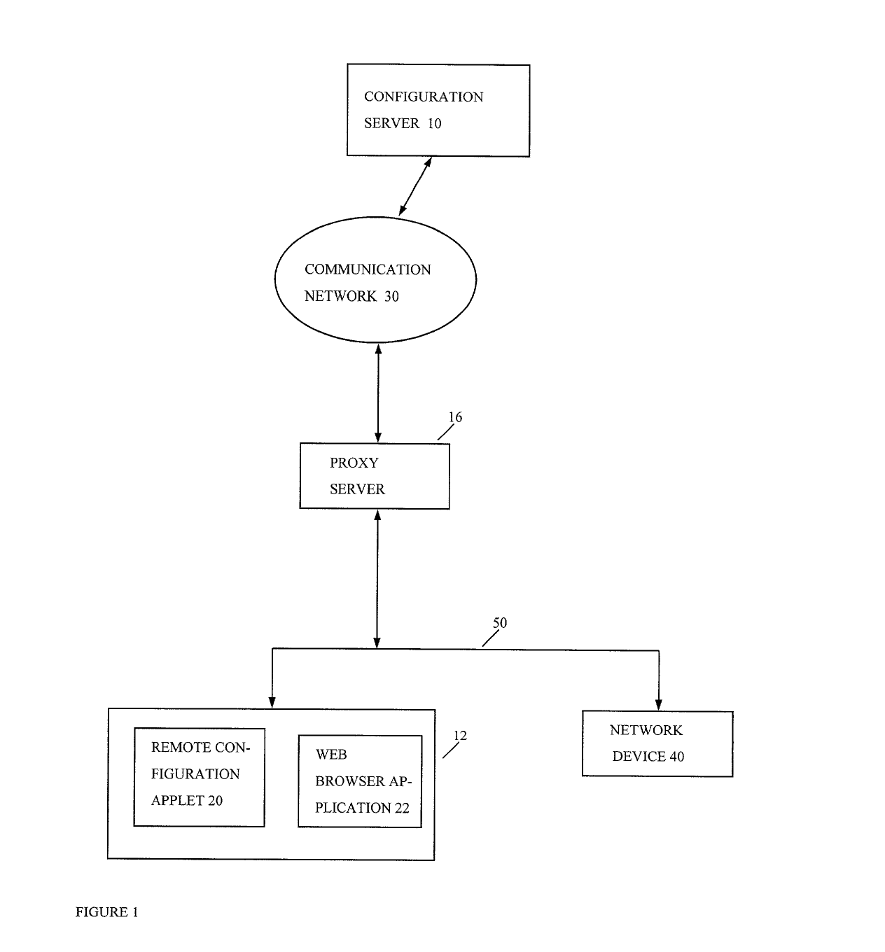

FIG. 1 illustrates an arrangement for configuring a network device 40 according to the present teachings. The network device 40 is coupled to a local network 50. The network device 40 is configured using a node 12 which is connected to the local network 50 and which configures the network device 40 under control of a configuration server 10. The node 12 communicates with the configuration server 10 via a communication network 30.

In one embodiment, the communication network 30 may be the world-wide web of the Internet. Alternatively, the communication network 30 may be another communication network which supports the Hyper-Text Transfer Protocol (HTTP). In other embodiments, other client-server communication protocols may be employed. The local network 50 may be, for example, an Ethernet local area network.

In this embodiment, devices on the local network 50 communicate with devices on the communication network 30 through a proxy server 16. The proxy server 16 may provide firewall protection to devices on the local network 50. In other embodiments, the proxy server 16 may not be present.

The node 12 includes a set of hardware/software resources for executing a remote configuration applet 20 and a web browser application 22. The remote configuration applet 20 searches the local network 50 for network devices such as the network device 40 that are capable of being configured. The remote configuration applet 20 notifies the configuration server 10 via the communication network 30 when the network device 40 is found. The network device 40 may be undergoing an initial configuration or an update to its configuration.

The web browser application 22 generates a set of network configuration parameters for the network device 40 under control of the configuration server 10. The configuration server 10 provides the network configuration parameters to the remote configuration applet 20 via the communication network 30. The remote configuration applet 20 relays the network configuration parameters onto the network device 40 via the local network 50.

Once the network device 40 is provided with the network communication parameters, it may access other devices such as the configuration server 10 using Internet protocols.

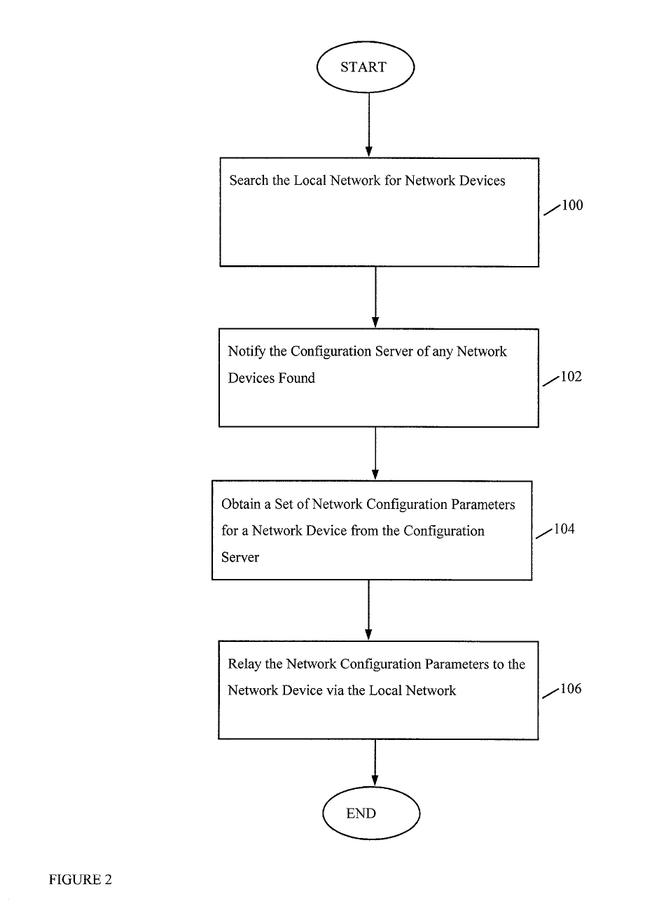

FIG. 2 shows method steps performed by the remote configuration applet 20 in one embodiment. At step 100, the remote configuration applet 20 searches for network devices that are connected to the local network 50. In this example, the network device found at step 100 is the network device 40.

In one embodiment, the remote configuration applet 20 searches for network devices using a multi-cast protocol. The remote configuration applet 20 generates a multi-cast query message and transfers it via the local network 50. The multi-cast query message includes a header that targets multi-cast capable devices. Only multi-cast capable devices on the local network 50 respond to the multi-cast query message. The remote configuration applet 20 gathers data on the network devices on the local network 50 that respond to the multi-cast query message. A response from a network device to a multi-cast query message includes a set of current configuration information for the network device. When a network device responds to a multi-cast query message it indicates that the network device is capable of being configured.

In another embodiment, the remote configuration applet 20 searches for network devices on the local network 50 using the TCP/IP protocol.

At step 102, the remote configuration applet 20 notifies the configuration server 10 of the network device 40 found at step 100. For example, the remote configuration applet 20 may send a message to the configuration server 10 via the communication network 30 using Internet protocols. The message may include an identifier and/or related information for the network device 40.

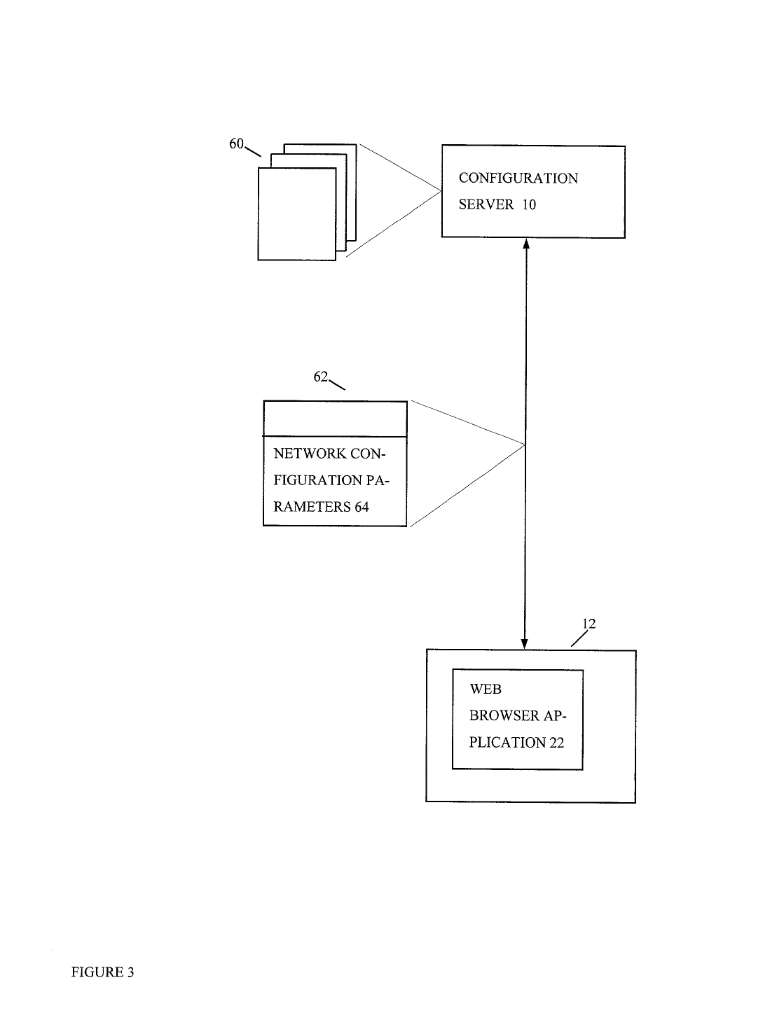

FIG. 3 illustrates a method for generating a set of network configuration parameters 64 for the network device 40 under control of the configuration server 10. The configuration server 10 generates a set of configuration web pages 60 in response to the notification at step 102. The web browser application 22 enables a user to access the configuration web pages 60. The configuration web pages 60 guide the user through the process of generating the network configuration parameters 64.

The configuration web pages 60 may include forms that enable a user to enter an address for the network device 40.

The configuration web pages 60 may include forms that enable a user to enter an address for the configuration server 10.

The configuration web pages 60 may include forms that enable a user to enter an address for other devices on the local network 50 such as the proxy server 16.

In one embodiment, the addresses that may be configured for the network device 40 are IP address that will enable the network device 40 to communicate using Internet protocols. In other embodiments, other types of addresses may be configured depending on the type of communication involved.

Alternatively, the configuration server 10 may automatically generate the network configuration parameters 64 without input by a user.

At step 104, the remote configuration applet 20 obtains the network configuration parameters 64 from the configuration server 10. For example, the configuration server 10 may send a message 62 to the remote configuration applet 20 via the communication network 30 using Internet protocols. The message 62 carries the network configuration parameters 64 along with a command that instructs the remote configuration applet 20 to relay the network configuration parameters 64 onto the network device 40.

At step 106, the remote configuration applet 20 transfers the network configuration parameters 64 to the network device 40 via the local network 50. For example, the remote configuration applet 20 may send the network communication parameters 64 via the local network 50 using a multi-cast protocol. Alternatively, the remote configuration applet 20 may send the network communication parameters 64 via the local network 50 using the TCP/IP protocol.

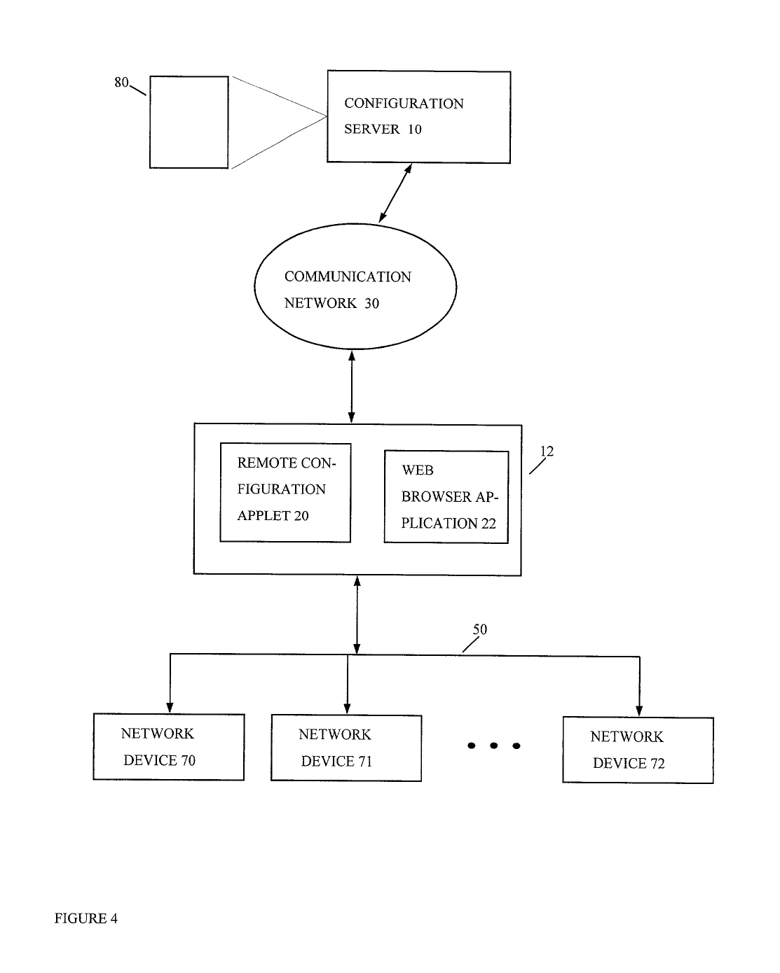

FIG. 4 illustrates an arrangement for configuring a set of network devices 70-72 according to the present teachings. The network devices 70-72 and the node 12 are coupled to the local network 50. The node 12 communicates with the configuration server 10 via the communication network 30 with or without an intervening proxy server.

Any one or more of the network devices 70-72 may need to be configured. A user employs the web browser application 22 to access a network device configuration web page 80 which is generated by the configuration server 10. The network device configuration web page 80 include a hyperlink that when selected loads the remote configuration applet 20 into the node 12 and executes it. The remote configuration applet 20 searches the local network 50 for any of the network devices 70-72 that are capable of being configured and reports the results back to the configuration server 10. The user of the web browser application 22 generates network configuration parameters for the network devices under control of the configuration server 10 as describe above. The configuration server 10 sends the network configuration parameters to the remote configuration applet 20 which relays them onto the network devices 70-71 via the local network 50.

In one embodiment, the remote configuration applet 20 is a Java applet. The web browser application 22 includes a Java virtual machine for executing the remote configuration applet 20 in Java.

The node 12 includes hardware and software resources and communication resources for executing the web browser application 22 and the remote configuration applet 20 and for performing communication via the communication network 30 and the local network 50. For example, the node 12 includes the capability of transferring multi-cast query messages and detecting responses from network devices. The node 12 may be embodied as a computer system such as a personal computer or engineering workstation with an operating system that supports widely available web browser applications including those that support Java applets.

The foregoing detailed description of the present invention is provided for the purposes of illustration and is not intended to be exhaustive or to limit the invention to the precise embodiment disclosed. Accordingly, the scope of the present invention is defined by the appended claims.

What is claimed is:

1. A method for configuring a network device, comprising the steps of:
generating a set of network configuration parameters for the network device under control of a configuration server;
transferring the network configuration parameters to the network device via a local network of the network device.

2. The method of claim 1, further comprising the step of searching the local network for the network device.

3. The method of claim 2, wherein the step of generating a set of network configuration parameters comprises the steps of:
notifying the configuration server of the network device found;
generating a set of web pages that enable a user to enter the network configuration parameters.

4. The method of claim 3, wherein the web pages enable the user to enter an address for the network device.

5. The method of claim 3, wherein the web pages enable the user to enter an address for a proxy server on the local network.

6. The method of claim 3, wherein the web pages enable the user to enter an address for the configuration server.

7. A system for configuring a network device, comprising:
configuration server coupled to a communication network;
node coupled to a local network of the network device, the node having means for generating a set of network configuration parameters for the network device under control of the configuration server.

8. The system of claim 7, wherein the means for generating a set of network configuration parameters include means for executing a remote configuration applet that searches the local network for the device.

9. The system of claim 8, wherein the remote configuration applet searches by transferring a multi-cast query message via the local network and detecting responses.

10. The system of claim 7, wherein the means for generating a set of network configuration parameters include means for executing a remote configuration applet that notifies the configuration server of the network device.

11. The system of claim 7, wherein the means for generating a set of network configuration parameters include means for executing a remote configuration applet that relays the network configuration parameters to the network device.

12. The system of claim 7, wherein the means for generating a set of network configuration parameters include means for executing a web browser application that enables a user to access a set of web pages generated by the configuration server for entering the network configuration parameters.

13. The system of claim 12, wherein the web pages enable the user to enter an address for the network device.

14. The system of claim 12, further comprising a proxy server that enables communication between the communication network and the local network.

15. The system of claim 14, wherein the web pages enable the user to enter an address for the proxy server.

16. The system of claim 12, wherein the web pages enable the user to enter an address for the configuration server.
